(19) United States
(12) Patent Application Publication
(10) Pub. No.: US 2025/0247573 A1
(43) Pub. Date: Jul. 31, 2025

(54) SYSTEM AND METHOD FOR STREAM DISTRIBUTION

(71) Applicant: 17LIVE Japan INC., Tokyo (JP)

(72) Inventors: Durgesh KUMAR, Tokyo (JP); Nitin SRIVASTAVA, Tokyo (JP); Manasvi GHELANI, Tokyo (JP); Abinash SEN, Tokyo (JP); Yen-Hsuan LEE, Taipei City (TW); Yun-Chieh WANG, Taipei City (TW); Shih-Bo LIN, Taipei City (TW)

(21) Appl. No.: 19/023,046

(22) Filed: Jan. 15, 2025

(30) Foreign Application Priority Data
Jan. 25, 2024 (JP) 2024-009628

(51) Int. Cl. H04N 21/25; H04N 21/2187; H04N 21/234; H04N 21/431; H04N 21/482

(52) U.S. Cl. CPC H04N 21/251; H04N 21/2187; H04N 21/23418; H04N 21/4312; H04N 21/4826

(57) ABSTRACT

The present disclosure relates to a system and a method for stream distribution. The method includes: determining an idle score of a distributor in a live stream of the distributor; and determining a priority score of recommending the live stream to a first viewer according to the idle score of the distributor, wherein the idle score increases as the distributor is less active in the live stream.

### CROSS-REFERENCE TO RELATED APPLICATIONS

This application is based on and claims the benefit of priority from Japanese Patent Application Serial No. 2024-009628 (filed on Jan. 25, 2024), the contents of which are hereby incorporated by reference in their entirety.

### BACKGROUND OF THE DISCLOSURE

### Technical Field

The present disclosure relates to stream distribution and, more particularly, to live stream distribution.

### Background

Real time interaction on the Internet, such as live streaming service, has become popular in our daily life. There are various platforms or providers providing the service of live streaming, and the competition is fierce. It is important for a platform to provide its users their desired services.

Japanese patent application publication JP2019-164617A discloses a system for recommending live videos to users.

### SUMMARY

A method according to one embodiment of the present disclosure is a method for stream distribution being executed by one or a plurality of computers, and includes: determining an idle score of a distributor in a live stream of the distributor; and determining a priority score of recommending the live stream to a first viewer according to the idle score of the distributor, wherein the idle score increases as the distributor is less active in the live stream.

A system according to one embodiment of the present disclosure is a system for stream distribution that includes one or a plurality of processors, and the one or plurality of computer processors execute a machine-readable instruction to perform: determining an idle score of a distributor in a live stream of the distributor; and determining a priority score of recommending the live stream to a first viewer according to the idle score of the distributor, wherein the idle score increases as the distributor is less active in the live stream.

A non-transitory computer-readable medium including a program for stream distribution, wherein the program causes one or a plurality of computers to execute: determining an idle score of a distributor in a live stream of the distributor; and determining a priority score of recommending the live stream to a first viewer according to the idle score of the distributor, wherein the idle score increases as the distributor is less active in the live stream.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the behavior DB 330.

FIG. 8 is a data structure diagram showing an example of the behavior DB 330.

FIG. 9 is a data structure diagram showing an example of the idle score DB 332.

FIG. 10 is a data structure diagram showing an example of the priority score DB 334.

FIG. 11 shows an example of recommending a stream to a user according to some embodiments of the present disclosure.

FIG. 12 shows an exemplary flow according to some embodiments of the present disclosure.

FIG. 13 shows an exemplary user interface according to some embodiments of the present disclosure.

FIG. 14 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

A streaming platform would like to recommend good streams to viewers, and would like to prevent recommending bad streams to viewers. Good streams are streams that may increase the viewers' engagement or interaction in the streams. Bad streams are streams that may decrease the viewers' engagement or interaction in the streams. A method or system to increase the overall engagement or interaction of the viewers on the platform is desirable.

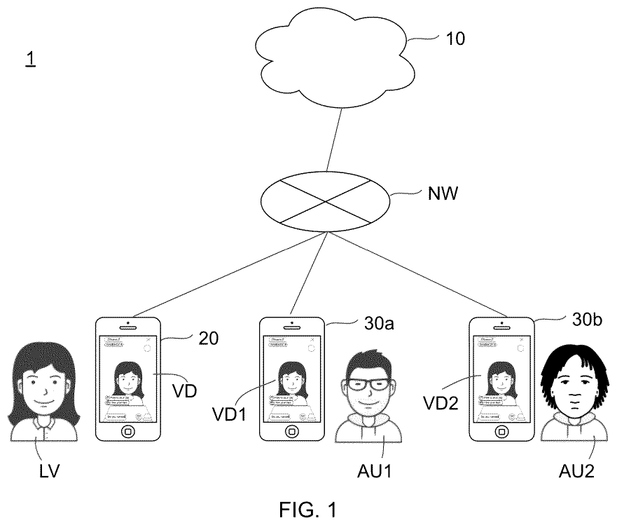

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server 10, and the server 10 provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal 20 and video data reproduction at the viewer's user terminal 30, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal 20 and then played back at the viewer's user terminal 30 via the server 10, the video data generated at the distributor's user terminal 20, the video data that passes through the server 10, and the video data received and reproduced at the viewer's user terminal 30 are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

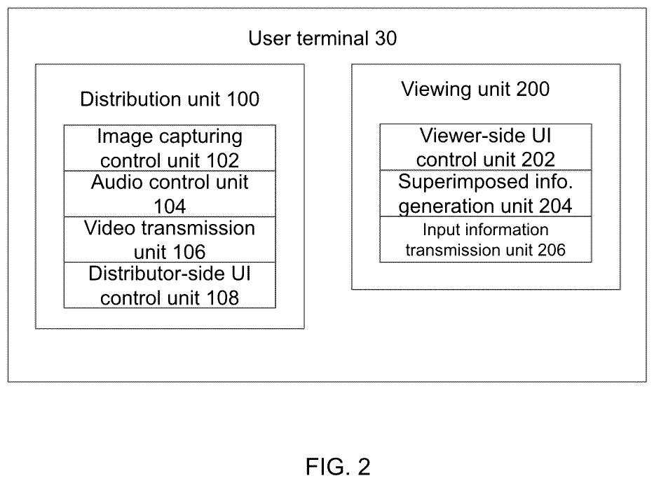

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distributor-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distributor-side UI control unit 108 controls an UI (user interface) for the distributor. The distributor-side UI control unit 108 may be connected to a display (not shown in FIG. 2), and displays a video on the display by reproducing the video data that is to be transmitted by the video transmission unit 106. The distributor-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

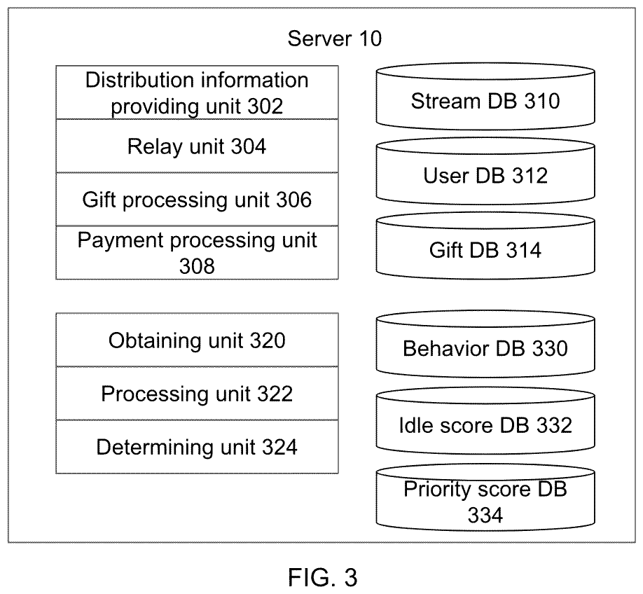

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a processing unit 322, a determining unit 324, a behavior DB 330, an idle score DB 332, and a priority score DB 334.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

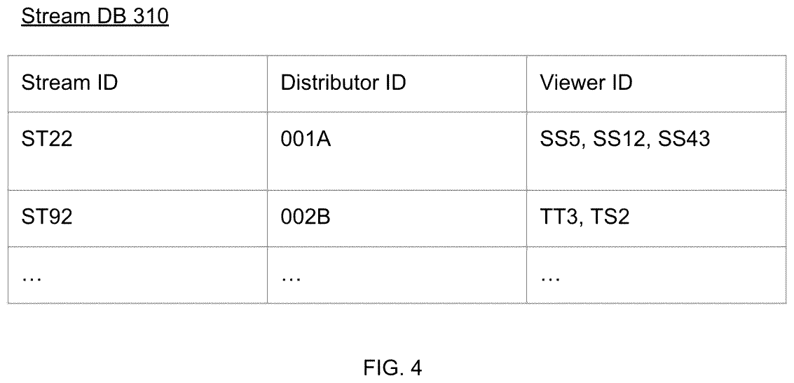

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

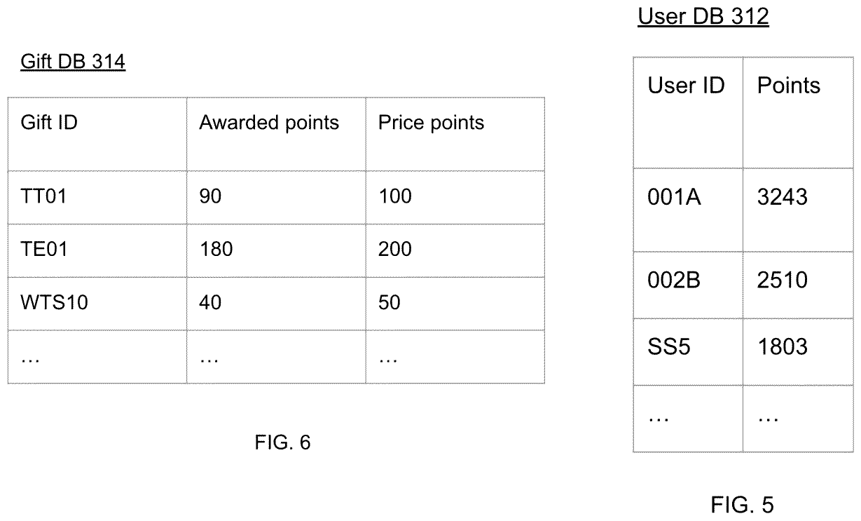

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

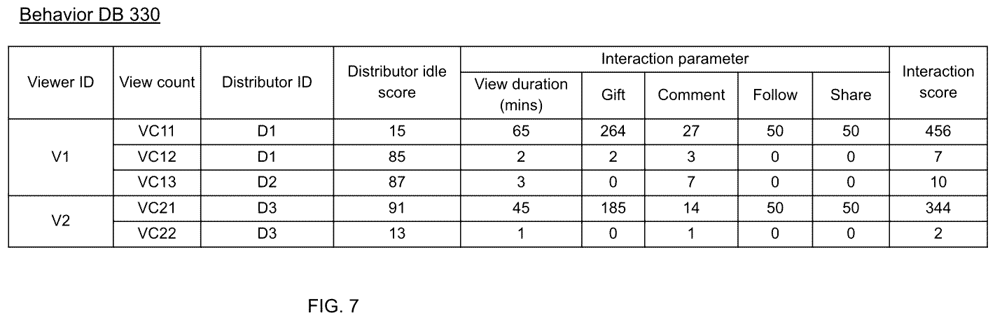

FIG. 7 is a data structure diagram showing an example of the behavior DB 330. The behavior DB 330 stores the viewer ID, the view count, the distributor ID, the distributor idle score, the interaction parameter, and the interaction score, in association with each other.

The view count is the count or the index of the viewing record of the viewer. In some embodiments, different view counts correspond to different viewing sessions, at different timings.

The distributor idle score indicates the degree (or the level) of an idle status of the distributor (or the stream of the distributor), at the timing (or the time span) corresponding to the view count. A higher idle score means the distributor (or the stream) is more closer to an idle status or is less active. A lower idle score means the distributor is more active in the stream. Details of an idle status will be explained later.

The interaction parameters include parameters such as view duration, gift, comment, follow, and share. The view duration is the time length the viewer spends in the stream of the corresponding distributor at the view count. The gift could be the gifting amount or the gift number the viewer contributes to the distributor at the view count. The comment could be the comment number the viewer sends to the distributor at the view count. The “follow” indicates whether or not the viewer makes a follow action with respect to the distributor at the view count. If yes, a predetermined score (in this embodiment it is 50) would be given. If not, the score is zero. The “share” indicates whether or not the viewer makes a share action for the stream of the distributor at the view count. If yes, a predetermined score (in this embodiment it is 50) would be given. If not, the score is zero.

The interaction score is calculated based on the interaction parameters. Various calculation methods could be utilized according to the actual practice or the focus point of the platform. For example, in this embodiment, the interaction score is the sum of the values of the interaction parameters.

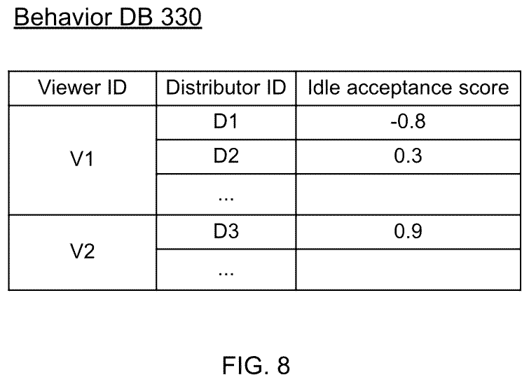

FIG. 8 is a data structure diagram showing an example of the behavior DB 330. The behavior DB 330 stores the viewer ID, the distributor ID, and the idle acceptance score, in association with each other.

The idle acceptance score indicates the acceptance level of the viewer with respect to the idle status of the corresponding distributor. The idle acceptance score could be calculated utilizing the data shown in FIG. 7. In some embodiments, the idle acceptance score could be the correlation coefficient between the distributor idle score and the viewer interaction score, with respect to the same distributor. In some embodiments, the distributor idle score and the interaction score could be calculated in a real time manner. Therefore, the idle acceptance score could also vary in a real time manner.

For example, in FIG. 7, between viewer V1 and distributor D1: at the view count VC11, the distributor idle score is low (15) and the viewer interaction score is high (456). At the view count VC12, the distributor idle score is high (85) and the viewer interaction score is low (7). That means viewer V1 interacts more when distributor D1 is more active (or less idle). Therefore, the idle acceptance score (or the correlation coefficient) is negative (−0.8) in FIG. 8.

For example, in FIG. 7, between viewer V2 and distributor D3: at the view count VC21, the distributor idle score is high (91) and the viewer interaction score is high (344). At the view count VC22, the distributor idle score is low (13) and the viewer interaction score is low (2). That means viewer V3 interacts more when distributor D3 is less active (or more idle). Therefore, the idle acceptance score (or the correlation coefficient) is positive (0.9) in FIG. 8.

In some embodiments, for a new viewer of a distributor, the idle acceptance score would be set low, because the viewer has never watched streams of the distributor and there is no interaction parameters between them.

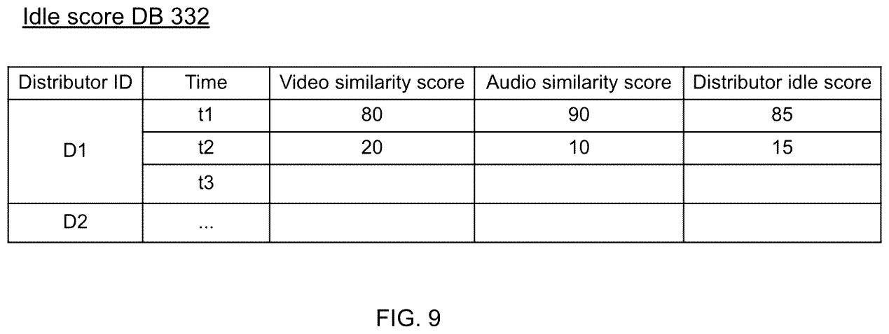

FIG. 9 is a data structure diagram showing an example of the idle score DB 332. The idle score DB 332 stores the distributor ID, the time, the video similarity score, the audio similarity, and the distributor idle score, in association with each other.

The times t1, t2, . . . could be different timings or different time spans.

The video similarity score indicates the similarity level between video data (or image data) of adjacent frames of the stream of the distributor. The adjacent frames could be frames near the timing t1 (or within the time span t1). For example, in some embodiments, the processing unit 322 may screenshot 24 images of the stream within time span t1 (which could be, for example, 4 mins). The processing unit 322 then computes how similar each image is to every other image, and gives a similarity score for each possible pair. An average video similarity score for the time span t1 could also be calculated. A higher score indicates the frames are more similar to each other, that is, less change of the stream image (or less change of the distributor action). Various methods for calculating the video similarity score could be utilized, such as RMSE, PSNR, SSIM, UQI, SIFT, or deep learning.

The audio similarity score indicates the similarity level between audio data (or distributor's voice data) of adjacent audio clips of the stream of the distributor. The adjacent audio clips could be audio clips near the timing t1 (or within the time span t1). For example, in some embodiments, the processing unit 322 may sample 15 audio clips of the stream within time span t1 (which could be, for example, 4 mins). The processing unit 322 then computes how similar each audio clip is to every other audio clip, and gives a similarity score for each possible pair. An average audio similarity score for the time span t1 could also be calculated. A higher score indicates the audio clips are more similar to each other, that is, less change of the stream sound (or less change of the distributor sound). Various methods for calculating the audio similarity score could be utilized, such as deep learning.

The distributor idle score indicates the idle level of the distributor (or the live stream of the distributor), and is calculated by the video similarity score and/or the audio similarity score. The distributor idle score may increase along with the video similarity score and/or the audio similarity score. A higher score indicates the distributor is more in an idle status or is less active. For example, if the distributor is absent (not in the stream) and the background keeps unchanged, the video similarity score would be very high, and the distributor idle score would be high. For example, if the distributor does not talk and keeps silent, the audio similarity score would be very high, and the distributor idle score would be high. In the embodiment of FIG. 9, the distributor idle score is the average of the video similarity score and the audio similarity score. The distributor idle score could be calculated in a real time manner, and may vary according to the actual idle status in the stream.

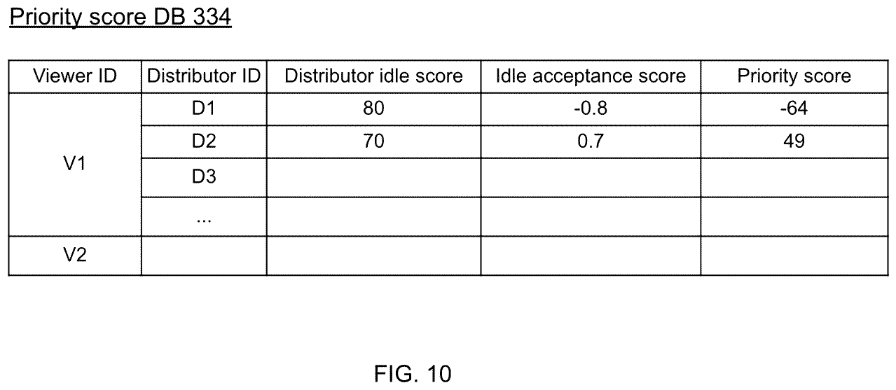

FIG. 10 is a data structure diagram showing an example of the priority score DB 334. The priority score DB 334 stores the viewer ID, the distributor ID, the distributor idle score, the idle acceptance score, and the priority score, in association with each other.

The distributor idle score could be accessed from the idle score DB 332 in a real time manner.

The idle acceptance score could be accessed from the behavior DB 330.

The priority score indicates the priority of recommending the stream (or live stream) of the distributor to the viewer. The priority score is calculated according to the distributor idle score and the idle acceptance score. For example, in this embodiment, the priority score is the product of the distributor idle score and the idle acceptance score. That is, the priority score is the distributor idle score times the idle acceptance score.

For example, in FIG. 10, at the timing of the calculation (or at the timing of the recommendation), the distributor idle score of distributor D1 is high (80) and indicates distributor D1 is in an idle status, and the negative idle acceptance score (−0.8) indicates a low acceptance for viewer V1 with respect to distributor D1's idle status, therefore the priority score is low (−64).

For example, in FIG. 10, at the timing of the calculation (or at the timing of the recommendation), the distributor idle score of distributor D2 is high (70) and indicates distributor D2 is in an idle status, and the positive idle acceptance score (0.7) indicates a high acceptance for viewer V1 with respect to distributor D2's idle status, therefore the priority score is higher (49).

The obtaining unit 320 is configured to obtain values to be stored in the behavior DB 330, the idle score DB 332, and/or the priority score DB 334. For example, the obtaining unit 320 may obtain view duration data, gift data, comment data, follow data, and/or share data from a monitoring unit (within or outside server 10), or from user terminals of viewers, and store them into the behavior DB 330.

The processing unit 322 is configured to calculate or determine values in the behavior DB 330, the idle score DB 332, and/or the priority score DB 334. For example, the processing unit 322 may calculate the interaction score, the idle acceptance score, the video similarity score, the audio similarity score, the distributor idle score, and/or the priority score.

The determining unit 324 is configured to determine a position of displaying the live stream of a distributor in a recommendation page on a user terminal of a viewer according to the priority score associated between the distributor and the viewer. A stream with a higher priority score with respect to the viewer would be placed in a higher or topper place. In some embodiments, a stream with a priority score less than a threshold will not be shown to the viewer.

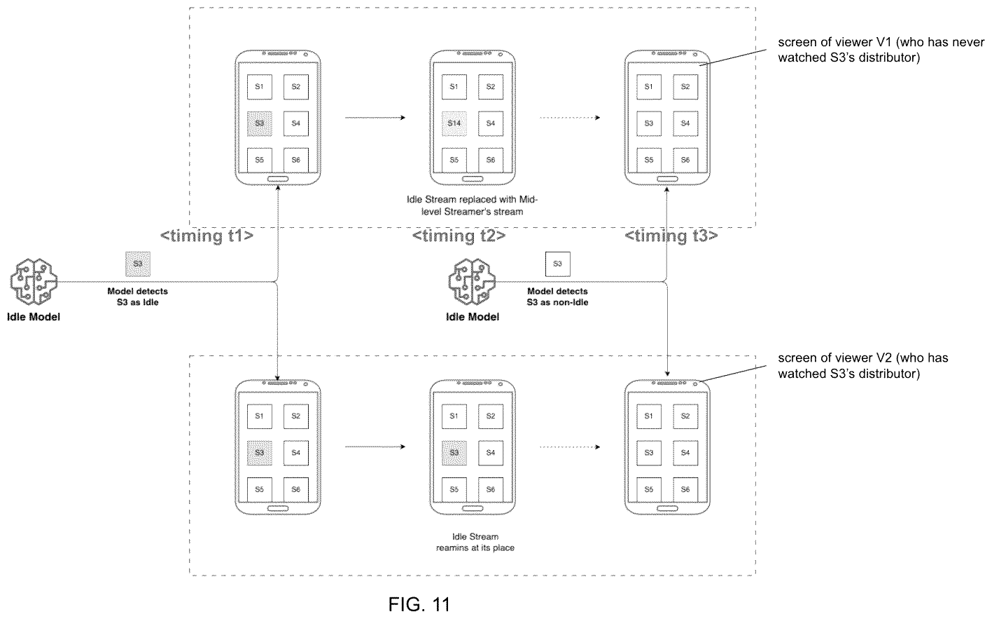

FIG. 11 shows an example of recommending a stream to a user according to some embodiments of the present disclosure.

The idle model could include the processing unit 322 and/or the determining unit 324, and could determine a stream as idle or not according to the distributor idle score of the stream. For example, the idle model may determine a stream as idle as the stream's distributor idle score (or the video similarity score, or the audio similarity score) is over a predetermined threshold. In some embodiments, if the distributor idle score has surpassed a certain threshold for a predetermined time length, the model will tag the stream as idle.

At timing t1, streams S1, S2, S3, S4, S5, and S6 are displayed in the recommendation page on the screens of viewer V1 and viewer V2. Stream S3 is distributed by distributor D3. Viewer V1 has never watched distributor D3's stream before. Viewer V2 has watched distributor D3's stream before. The idle model detects stream S3 as idle.

At timing t2, the idle model removed stream S3 from the recommendation page on the screen of viewer V1, and replaced it with stream S14. Stream S14 is distributed by a mid-level distributor D14, who is considered to be generally popular for the majority of viewers. Because viewer V1 is a new viewer of distributor D3, the idle acceptance score associated between viewer V1 and distributor D3 is low, therefore the recommending priority of stream S3 is low to viewer V1 when stream S3 is marked as idle.

At timing t2, the idle model remained stream S3 in the recommendation page on the screen of viewer V2. Because viewer V2 is not a new viewer of distributor D3, the idle acceptance score associated between viewer V2 and distributor D3 may be high, therefore the recommending priority of stream S3 is not low to viewer V2 even when stream S3 is marked as idle.

At timing t3, the idle model detects stream S3 as non-idle (its distributor idle score dropped below the threshold). The idle model then recovered the recommending place for stream S3 to viewer V1. The recommending place could be determined according to some other logics such as similarity matching between streams and viewer V1.

In some embodiments, for a stream marked as idle, the idle model continuously detects whether the idled distributor is back or not.

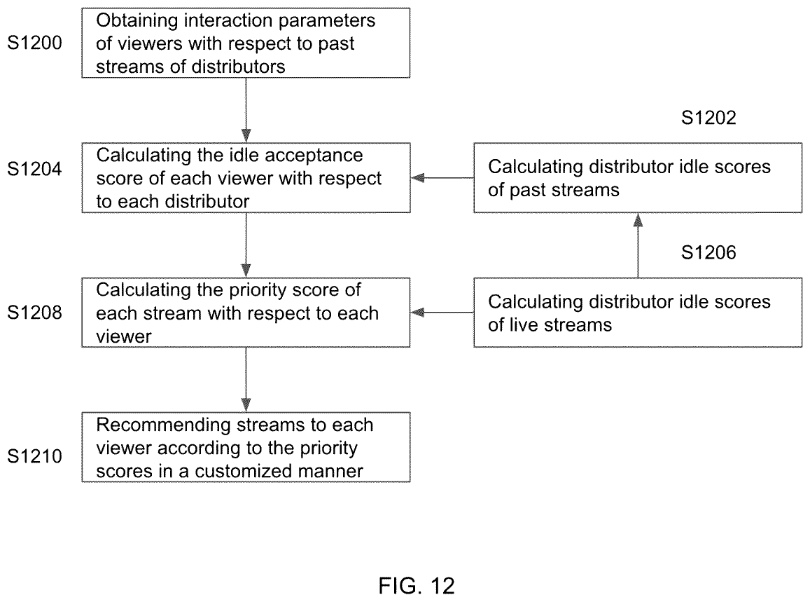

FIG. 12 shows an exemplary flow according to some embodiments of the present disclosure.

At step S1200, the obtaining unit 320 obtains interaction parameters of viewers with respect to past streams of distributors.

At step S1202, the process unit 322 calculates distributor idle scores of past streams (or distributor idle scores of past portions of live streams), according to video/audio similarity data of the streams.

At step S1204, the processing unit 322 calculates the idle acceptance score of each viewer with respect to each distributor, according to the interaction parameters and the distributor idle scores.

At step S1206, the processing unit 322 calculates distributor idle scores of live streams of distributors, according to video/audio similarity data of the live streams. In some embodiments, step S1206 could be part of step S1202.

At step S1208, the processing unit 322 calculates the priority score of each live stream with respect to each viewer, according to the viewer's acceptance score and the distributor's distributor idle score.

At step S1210, the determining unit 324 recommends streams to each viewer according to the priority score of each stream with respect to the viewer, in a customized manner.

Conventionally, even if a stream is idling, it may stay on top for some viewers in the recommendation page based on previous performance of the distributor. Some embodiments of the present disclosure could deprioritize the idle stream for viewers who haven't seen that distributor before. Those viewers do not have any prior experience with that distributor and may not enjoy an idle status of the distributor.

For some viewers, they may want to gift to the distributor during idle time of the distributor, in order to surprise the distributor when he or she is back from the idle status. Or, some viewers don't want to gift when many viewers are gifting or interacting with the distributor, and they tend to gift or comment more during idle time of the distributor. The present disclosure could identify those viewers who may enjoy idle time of the distributor, and will not deprioritize the idle streams for those viewers.

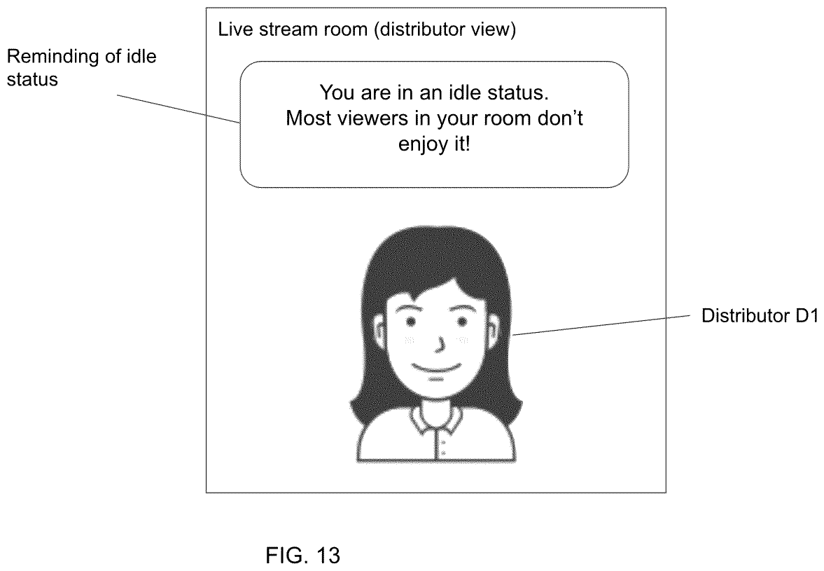

FIG. 13 shows an exemplary user interface according to some embodiments of the present disclosure. The interface is a stream room view from the distributor's perspective. As shown, when the distributor is detected to be idle, a visual message and/or an audio message may pop up to remind the distributor that most viewers don't enjoy the current idle status (for example, when the idle acceptance scores of most viewers with respect to the distributor are below a threshold). The processing unit 322 may be configured to perform the reminding process. For example, a distributor may be detected to be idle if he/she keeps using a cell phone in a still posture, instead of interacting with viewers.

In some embodiments, the processing unit 322 may generate a whitelist of distributors who are almost always in the idle status but most viewers enjoy the idle streams of them (for example, idle acceptance scores of 80% viewers with respect to those distributors are higher than a threshold). Streams of the whitelist distributors will not be deprioritized for all viewers.

In some embodiments, the processing unit 322 may generate a blacklist of distributors who are almost always in the idle status and most viewers don't enjoy the idle streams of them (for example, idle acceptance scores of 80% viewers with respect to those distributors are lower than a threshold). Once a distributor is classified into the blacklist, streams of the distributor will not be shown on the recommending page for all viewers.

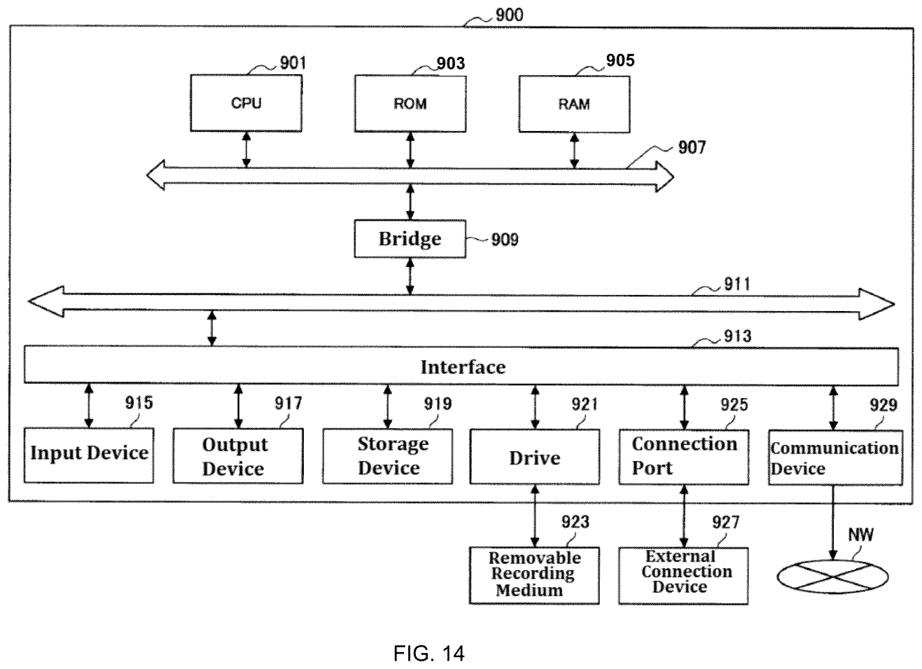

Referring to FIG. 14, the hardware configuration of the information processing device will be now described. FIG. 14 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system I in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

What is claimed is:

1. A method for stream distribution, executed by a server, comprising:
determining an idle score of a distributor in a live stream of the distributor; and
determining a priority score of recommending the live stream to a first viewer according to the idle score of the distributor,
wherein the idle score increases as the distributor is less active in the live stream.

2. The method according to claim 1, further comprising:
determining a first idle acceptance score of the first viewer with respect to the distributor; and
determining the priority score according to the idle score of the distributor and the first idle acceptance score of the first viewer,
wherein the first idle acceptance score increases as an acceptance level of the first viewer with respect to an idle status of the distributor increases.

3. The method according to claim 1, further comprising:
determining a position of displaying the live stream in a recommendation page on a user terminal of the first viewer according to the priority score.

4. The method according to claim 1, wherein the priority score is determined to be lower when the idle score is higher.

5. The method according to claim 2, wherein the priority score is determined to be high when the idle score is high and the first idle acceptance score is high.

6. The method according to claim 1, wherein the determining the idle score includes calculating a similarity score between at least two frames of the live stream.

7. The method according to claim 2, further comprising:
determining a second idle acceptance score of a second viewer with respect to the distributor, wherein the second idle acceptance score increases as an acceptance level of the second viewer with respect to the idle status of the distributor increases;
determining the distributor to be in the idle status according to the idle score;
determining the first idle acceptance score to be higher than a threshold;
determining the second idle acceptance score to be lower than the threshold;
determining to recommend the live stream to the first viewer; and
determining not to recommend the live stream to the second viewer.

8. The method according to claim 2, further comprising:
determining the idle score to be higher than an idle score threshold;
determining the first idle acceptance score to be lower than an acceptance score threshold; and
reminding the distributor of the idle status in the live stream.

9. A system for stream distribution, comprising one or a plurality of processors, wherein the one or plurality of processors execute a machine-readable instruction to perform:
determining an idle score of a distributor in a live stream of the distributor; and
determining a priority score of recommending the live stream to a first viewer according to the idle score of the distributor,
wherein the idle score increases as the distributor is less active in the live stream.

10. A non-transitory computer-readable medium including a program for stream distribution, wherein the program causes one or a plurality of computers to execute:
determining an idle score of a distributor in a live stream of the distributor; and
determining a priority score of recommending the live stream to a first viewer according to the idle score of the distributor,
wherein the idle score increases as the distributor is less active in the live stream.
